(19) United States
(12) Patent Application Publication
(10) Pub. No.: US 2013/0316477 A1
(43) Pub. Date: Nov. 28, 2013

(54) Method for Manufacturing Liquid Crystal Display Device

(71) Applicants: Jie Chen, Shenzhen (CN); Chunliang Lee, Shenzhen (CN)

(72) Inventors: Jie Chen, Shenzhen (CN); Chunliang Lee, Shenzhen (CN)

(73) Assignee: Shenzhen China Star Optoelectronics Technology Co. Ltd., Shenzhen City, Guangdong (CN)

(21) Appl. No.: 13/575,294

(22) PCT Filed: May 30, 2012
(86) PCT No.: PCT/CN2012/076308

§ 371 Date: Jul. 25, 2012

(30) Foreign Application Priority Data
May 22, 2012 (CN) 201210160543.0

(51) Int. Cl. H01L 31/18

(52) U.S. Cl. CPC H01L 31/18
USPC 438/27

(57) ABSTRACT

The present invention provides a method for manufacturing a liquid crystal display device, which includes (1) providing a substrate; (2) forming a black matrix on a surface of the substrate; (3) sequentially forming R, G, B on the surface of the substrate; (4) forming spacers on the surface of the substrate and at the same time forming supports, the supports being arranged to correspond to a site where an enclosing frame is to be set; and (5) coating sealant on the site of the surface of the substrates where the enclosing frame is to be set to form the enclosing frame thereby forming the CF substrate. The spacers and the supports are simultaneously formed on a substrate through masking operation so that box thickness between a TFT substrate and a CF substrate can be supported by the supports.

### BACKGROUND OF THE INVENTION

1. Field of the Invention

The present invention relates to the field of liquid crystal displaying, and in particular to a method for manufacturing a liquid crystal display device.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal display panel and a backlight module. The working principle of the liquid crystal display panel is that liquid crystal polymer molecules interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images.

As shown in FIG. 1, a liquid crystal display device is generally composed of an upper structure 100 of color filter (CF), a low substrate 200 of thin film transistor (TFT), and liquid crystal (LC) 300 and sealant 400 interposed between the upper substrate 100 and the lower substrate 200. A general manufacturing process comprises a front stage of array process (including thin film, yellow light, etching, and film stripping), an intermediate stage of cell process (including bonding TFT substrate and the CF substrate), and a rear stage of assembling process (including mounting drive ICs and printed circuit board). The front stage of array process generally makes the TFT substrate for controlling the movement of liquid crystal molecules. The intermediate stage of cell process generally introduces the liquid crystal between the TFT substrate and the CF substrate. The rear stage of assembling process generally mounts the drive ICs and combining the printed circuit board to effect driving the liquid crystal molecules to rotate for displaying images.

The process of introducing the liquid crystal 300 between the upper substrate 100 and the lower substrate 200 is generally a process referred to as one drop filling (ODF), which generally comprises several steps of coating the sealant 400, filling the liquid crystal 300, vacuum assembling, and high temperature curing. In the step of coating the sealant 400, it is often that fibers 500 are added to the sealant 400 to provide an effect of supporting box thickness. However, adding fibers 500 increases the manufacturing time and labor required, making it detrimental to controlling cost.

### SUMMARY OF THE INVENTION

An object of the present invention is to provide a method for manufacturing a liquid crystal display device, which comprises forming supports for supporting box thickness at the same time when spacers are formed on a substrate and the process is simple and cost is low.

To achieve the object, the present invention provides a method for manufacturing a liquid crystal display device, which comprises the following steps:

Step 1: providing a substrate;

Step 2: forming a black matrix on a surface of the substrate;

Step 3: sequentially forming R, G, B on the surface of the substrate;

Step 4: forming spacers on the surface of the substrate and at the same time forming supports, the supports being arranged to correspond to a site where an enclosing frame is to be set; and

Step 5: coating sealant on the site of the surface of the substrates where the enclosing frame is to be set to form the enclosing frame thereby forming the CF substrate.

The spacers and the supports are formed on the substrate simultaneously through masking operation.

The substrate is a glass substrate and the site where the enclosing frame is to be set is located at an outer side of the back matrix adjacent to edges of the substrate.

The supports are of a regular or irregular shape.

The supports are of a pillar structure.

The supports are located inside or outside the enclosing frame.

The supports are distributed in the enclosing frame in such a way to take an occupation rate of 0.5%-3%.

A portion of the supports is located in the enclosing frame and a remaining portion is located inside or outside the enclosing frame.

The supports are arranged in a continuous manner so as to be continuously set on the substrate.

The method for manufacturing a liquid crystal display device further comprises:

Step 6: dropping liquid crystal inside the enclosing frame;

Step 7: providing a TFT substrate;

Step 8: bonding the TFT substrate and the CF substrate together in such a way that the TFT substrate and the CF substrate are supported by the supports arranged therebetween in order to enclose the liquid crystal between the TFT substrate and the CF substrate; and

Step 9: subjecting the bonded TFT substrate and the CF substrate to curing at high temperature in order to cure the enclosing frame.

The efficacy of the present invention is that the present invention provides a method for manufacturing a liquid crystal display device, which forms a spacer and a support simultaneously on a substrate through masking operation so that box thickness between a TFT substrate and a CF substrate can be supported by the support whereby the process of the conventional technique where fibers are added in an enclosing frame for supporting the box thickness can be eliminated to simplify the process, while reducing labor deployment and lowering own manufacture cost.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a schematic view showing the structure of a conventional liquid crystal display device;

FIG. 2 is a flow chart illustrating a method for manufacturing a liquid crystal display device according to the present invention;

FIG. 3 is a schematic view showing the structure of a first embodiment of liquid crystal display device manufactured with the method for manufacturing a liquid crystal display device according to the present invention;

FIG. 4 is a perspective view showing a color filter (CF) substrate of FIG. 3;

FIG. 5 is a schematic view showing the structure of a second embodiment of a liquid crystal display device manufactured with the method for manufacturing a liquid crystal display device according to the present invention;

FIG. 6 is a schematic view showing the structure of a third embodiment of a liquid crystal display device manufactured with the method for manufacturing a liquid crystal display device according to the present invention;

FIG. 7 is a schematic view showing the structure of a fourth embodiment of a liquid crystal display device manufactured with the method for manufacturing a liquid crystal display device according to the present invention

FIG. 8 is a schematic view showing the structure of a fifth embodiment of a liquid crystal display device manufactured with the method for manufacturing a liquid crystal display device according to the present invention.

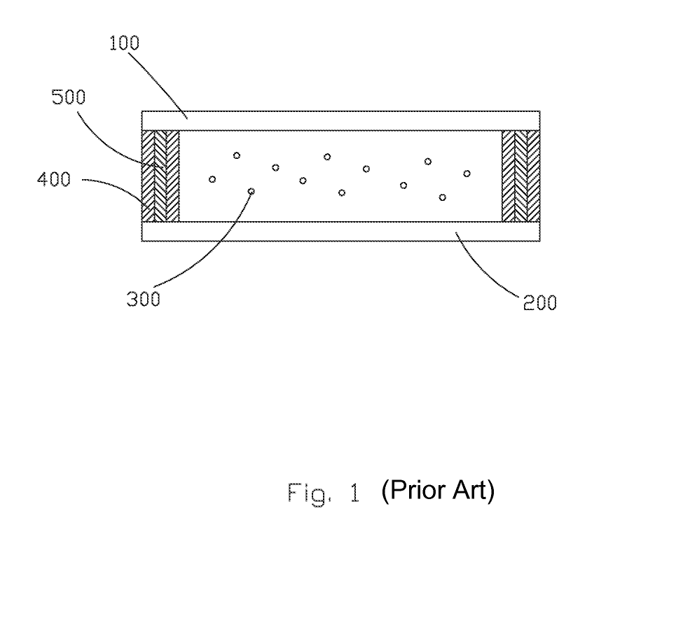

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

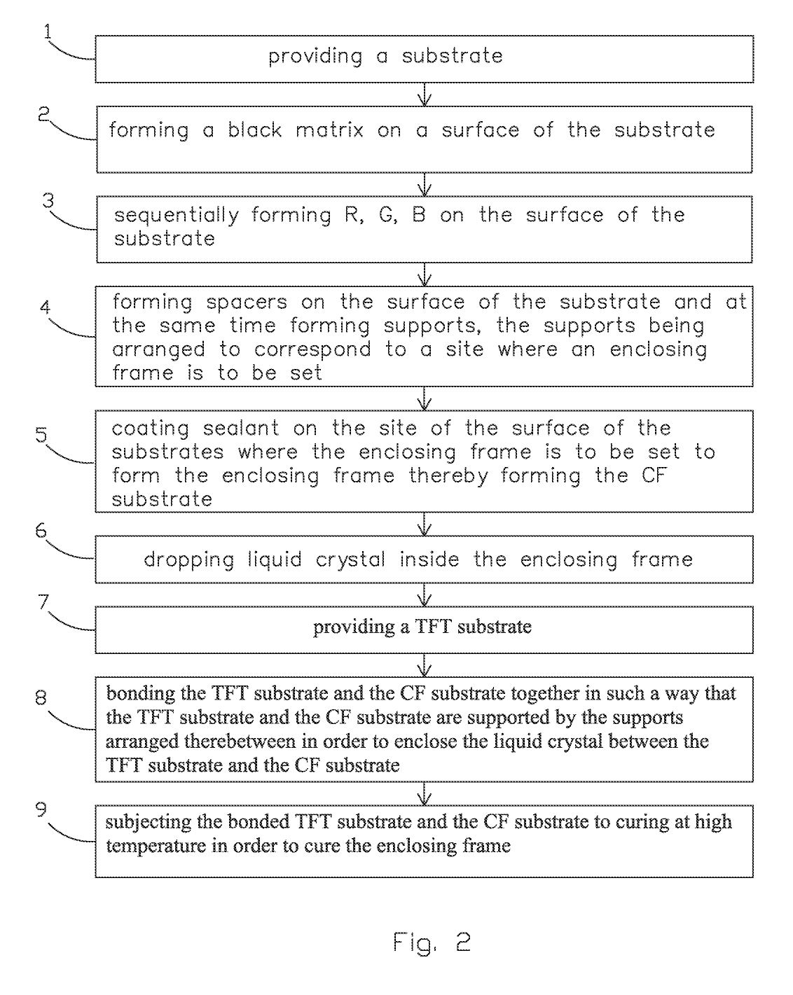

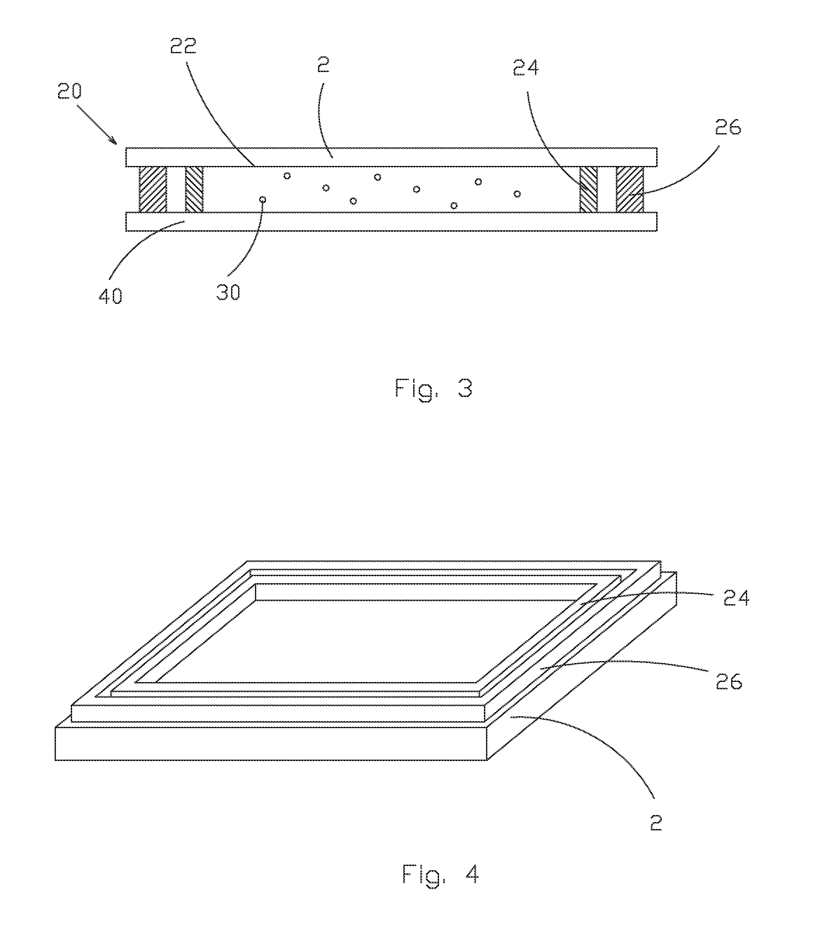

Referring to FIG. 2, with additional reference to FIGS. 3 and 4, the present invention provides a method for manufacturing liquid crystal display device, which comprises the following steps:

Step 1: providing a substrate 2. In the instant embodiment, the substrate 2 is a glass substrate.

Step 2: forming a black matrix (not shown) on a surface 22 of the substrate 2. The black matrix is integrally formed on the substrate 2 through operations including masking operation, printing, or spray coating operation.

Step 3: sequentially forming R, G, B on the surface 22 of the substrate 2.

The R, G, B are formed on the substrates 2 through operations including masking operation, printing, or spray coating operation.

Step 4: forming spacers (not shown) on the surface 22 of the substrate 2 and at the same time forming supports 24. The spacers and the supports 24 are formed on the substrate 2 through masking operation.

The supports 24 are arranged to correspond to the site where an enclosing frame is to be set. The site where the enclosing frame is to be set is located at an outer side of the back matrix adjacent to edges of the substrates. The supports 24 are arranged on the substrate 2 in a spaced manner. Preferably, the supports 24 are arranged on the substrate 2 in a uniformly spaced manner. The supports 24 can be arranged in a continuous manner so as to be continuously set on the substrate 2.

The supports 24 can be of a regular or irregular shape. Preferably, the supports 24 are of a pillar structure, of which the specific shape can be determined according to the requirement of an actual manufacturing process to achieve the same technical effect of the present invention.

Step 5: coating sealant on the site of the surface 22 of the substrates 2 where the enclosing frame is to be set to form the enclosing frame 26 thereby forming the CF substrate 20.

The supports 24 are arranged to correspond to the site where the enclosing frame is to be set and can be located inside or outside the enclosing frame 26 or completely located on the enclosing frame 26. As shown in FIGS. 3 and 4, as an optional embodiment of the present invention, in the instant embodiment, the supports 24 are located inside the enclosing frame 26.

Step 6: dropping liquid crystal 30 inside the enclosing frame 26.

Step 7: providing a TFT substrate 40.

The TFT substrate 40 is manufactured through the operations of thin film, yellow light, etching, and film stripping and the specific operations used can be any of the known operations.

Step 8: bonding the TFT substrate 40 and the CF substrate 20 together in such a way that the TFT substrate 40 and the CF substrate 20 are supported by the supports 24 arranged therebetween in order to enclose the liquid crystal 30 between the TFT substrate 40 and the CF substrate 20 thereby achieving supporting of box thickness between the TFT substrate 40 and the CF substrate 20 by the supports 24. This simplifies the manufacture process and reduces the manufacture cost.

Step 9: subjecting the bonded TFT substrate 40 and the CF substrate 20 to curing at high temperature in order to cure the enclosing frame 26.

Referring to FIG. 5, a schematic view showing the structure of a second embodiment of liquid crystal display device manufactured with the method for manufacturing liquid crystal display device according to the present invention is given. In the instant embodiment, the supports 24 are located outside the enclosing frame 26.

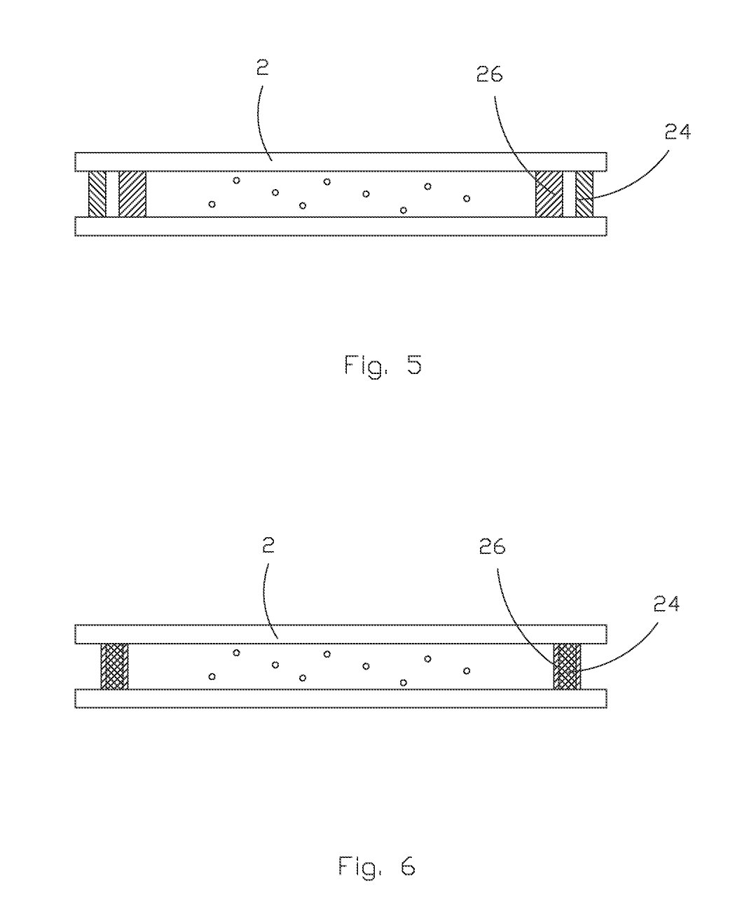

Referring to FIG. 6, a schematic view showing the structure of a third embodiment of liquid crystal display device manufactured with the method for manufacturing liquid crystal display device according to the present invention is given. In the instant embodiment, the supports 24 are located on the enclosing frame 26. The supports 24 are distributed on the enclosing frame 26 in such a way to take an occupation rate of 0.5%-3% in order to ensure the effect of supporting while lowering down the manufacture cost.

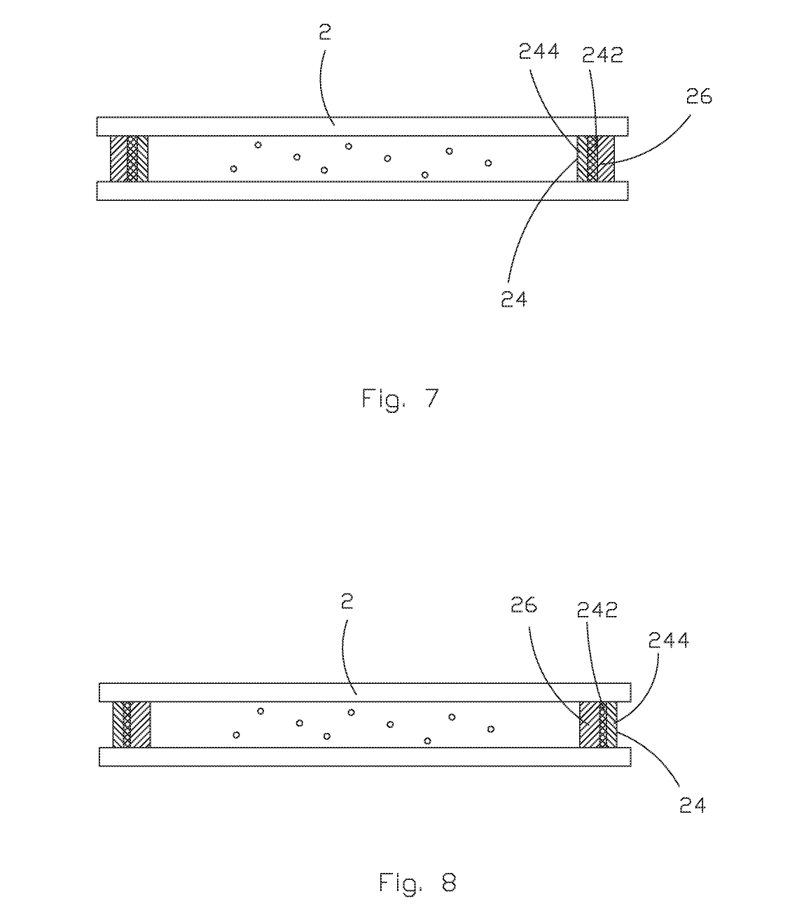

Referring to FIG. 7, a schematic view showing the structure of a fourth embodiment of liquid crystal display device manufactured with the method for manufacturing liquid crystal display device according to the present invention is given. In the instant embodiment, a portion 242 of the supports 24 is located on the enclosing frame 26, while a remaining portion 244 is located inside the enclosing frame 26.

Referring to FIG. 8, a schematic view showing the structure of a fifth embodiment of liquid crystal display device manufactured with the method for manufacturing liquid crystal display device according to the present invention is given. In the instant embodiment, a portion 242 of the supports 24 is located on the enclosing frame 26, while a remaining portion 244 is located outside the enclosing frame 26.

In summary, the present invention provides a method for manufacturing liquid crystal display device, which forms a spacer and a support simultaneously on a substrate through masking operation so that box thickness between a TFT substrate and a CF substrate can be supported by the support whereby the process of the conventional technique where fibers are added in an enclosing frame for supporting the box thickness can be eliminated to simplify the process, while reducing labor deployment and lowering own manufacture cost.

Based on the description given above, those having ordinary skills of the art may easily contemplate various changes and modifications of the technical solution and technical ideas of the present invention and all these changes and modifications are considered within the protection scope of right for the present invention.

1. A method for manufacturing a liquid crystal display device, comprising the following steps:
(1) providing a substrate;
(2) forming a black matrix on a surface of the substrate;
(3) sequentially forming R, G, B on the surface of the substrate;
(4) forming spacers on the surface of the substrate and at the same time forming supports, the supports being arranged to correspond to a site where an enclosing frame is to be set; and
(5) coating sealant on the site of the surface of the substrates where the enclosing frame is to be set to form the enclosing frame thereby forming a color filter (CF) substrate;
wherein the sealant is coated in such a way that a portion of the supports is located in the enclosing frame and a remaining portion of the supports is located outboard an outside surface of the enclosing frame.

2. The method for manufacturing a liquid crystal display device as claimed in claim 1, wherein the spacers and the supports are formed on the substrate simultaneously through masking operation.

3. The method for manufacturing a liquid crystal display device as claimed in claim 1, wherein the substrate is a glass substrate and the site where the enclosing frame is to be set is located at an outer side of the back matrix adjacent to edges of the substrate.

4. The method for manufacturing a liquid crystal display device as claimed in claim 1, wherein the supports are of a regular or irregular shape.

5. The method for manufacturing a liquid crystal display device as claimed in claim 4, wherein the supports are of a pillar structure.

6. (canceled)

7. The method for manufacturing a liquid crystal display device as claimed in claim 1, wherein the portion of the supports is distributed in the enclosing frame in such a way to take an occupation rate of 0.5%-3%.

8. (canceled)

9. The method for manufacturing a liquid crystal display device as claimed in claim 1, wherein the supports are arranged in a continuous manner so as to be continuously set on the substrate.

10. The method for manufacturing a liquid crystal display device as claimed in claim 1, further comprising the following steps:
(6) dropping liquid crystal inside the enclosing frame;
(7) providing a thin film transistor (TFT) substrate;
(8) bonding the TFT substrate and the CF substrate together in such a way that the TFT substrate and the CF substrate are supported by the supports arranged therebetween in order to enclose the liquid crystal between the TFT substrate and the CF substrate; and
(9) subjecting the bonded TFT substrate and the CF substrate to curing at high temperature in order to cure the enclosing frame.

11. A method for manufacturing a liquid crystal display device, comprising the following steps:
(1) providing a substrate;
(2) forming a black matrix on a surface of the substrate;
(3) sequentially forming R, G, B on the surface of the substrate;
(4) forming spacers on the surface of the substrate and at the same time forming supports, the supports being arranged to correspond to a site where an enclosing frame is to be set;
(5) coating sealant on the site of the surface of the substrates where the enclosing frame is to be set to form the enclosing frame thereby forming a color filter (CF) substrate, wherein the sealant is coated in such a way that a portion of the supports is located in the enclosing frame and a remaining portion of the supports is located outboard an outside surface of the enclosing frame;
(6) dropping liquid crystal inside the enclosing frame;
(7) providing a thin film transistor (TFT) substrate;
(8) bonding the TFT substrate and the CF substrate together in such a way that the TFT substrate and the CF substrate are supported by the supports arranged therebetween in order to enclose the liquid crystal between the TFT substrate and the CF substrate; and
(9) subjecting the bonded TFT substrate and the CF substrate to curing at high temperature in order to cure the enclosing frame;
wherein the spacers and the supports are formed on the substrate simultaneously through masking operation;
wherein the substrate is a glass substrate and the site where the enclosing frame is to be set is located at an outer side of the back matrix adjacent to edges of the substrate;
wherein the supports are of a regular or irregular shape;
wherein the supports are of a pillar structure; and
wherein the portion of the supports is distributed in the enclosing frame in such a way to take an occupation rate of 0.5%-3%.
